(19) United States
(12) Patent Application Publication
(10) Pub. No.: US 2022/0314038 A1
(43) Pub. Date: Oct. 6, 2022

(54) FULL-FACED SHIELD

(71) Applicant: Pitamber Singh, Scarborough (CA)

(72) Inventor: Pitamber Singh, Scarborough (CA)

(21) Appl. No.: 17/219,885

(22) Filed: Apr. 1, 2021

(51) Int. Cl. A62B 7/10; A41D 13/11; A62B 18/08; A62B 23/02

(52) U.S. Cl. CPC A62B 7/10; A41D 13/1184; A62B 18/084; A62B 23/02; A62B 18/082

(57) ABSTRACT

Illustrated views of an exemplary full-faced shield for protecting a person from microscopic virus and/or bacteria in the air is presented. The full-faced shield is useful for providing an impervious protective layer for an entire face of a person. The full-faced shield is useful for preventing droplets in the air from contacting eyes, nose and mouth area of the person. Furthermore, the full-faced shield provides an enhanced level of protection compared to typical face masks.

### FIELD OF THE INVENTION

This invention relates to face masks. More particularly, it relates to a full face protective face mask.

### BACKGROUND

The ongoing COVID-19 pandemic was confirmed to have reached the United States in January 2020. The first confirmed case of local transmission was recorded in January, while the first known deaths happened in February. By the end of March, cases had occurred in all 50 U.S. states, the District of Columbia, and all inhabited U.S. territories except American Samoa. As of Jun. 24, 2020, the U.S. had the most confirmed active cases and deaths in the world. As of Jul. 16, 2020, its death rate was 419 per million people, the seventh-highest rate globally.

The Center for Disease Control (CDC) has issued a recommendation to the US population for prevention of contracting COVID 19 as well as other infectious diseases. Those recommendations are: 1) wash hands often; 2) avoid close contact (social distancing); 3) cover mouth and nose with a cloth face cover when around others; 4) cover cough or sneezes; 5) clean and disinfect; and 6) monitor your health daily.

A face shield, an item of personal protective equipment (PPE), aims to protect the wearer's entire face (or part of it) from hazards such as flying objects and road debris, chemical splashes (in laboratories or in industry), or potentially infectious materials (in medical and laboratory environments). With the recent CDC guidelines for COVID-19 pandemic, many have turned to shields that cover at least a part of their face, in particular their nose and mouth.

Recent events in our history remind us how susceptible humans are to contaminants in the air we breathe. Whether such contaminants are incidental such as dust, dirt, allergens or the like, or something more dangerous such as bacteria and viruses, many people turn to the use of scarves, masks or respirators for protection. While each of these offer varying levels of protection, face masks are often cumbersome to remove and put back on, while also causing some people to breathe their own carbon monoxide back in. While masks may provide protection against air that is being inhaled or exhaled, another method of possible infection is microscopic droplets hi the air that are exhaled by an infected person while talking, sneezing or simply breathing. While conventional eye protection may reduce contact with one's eyes, droplets that land near the eyes, nose or mouth remain possible sources of infection.

Accordingly, and in light of the foregoing, there exists a need for a device in which eyes, nose and mouth can be protected from direct contact against microscopic infectious droplets. The development of the face mask with a removable opening fulfills this need.

### BRIEF DESCRIPTION OF THE DRAWINGS

FIG. 1A and FIG. 1B are illustrated views of an exemplary shopping full-faced shield.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

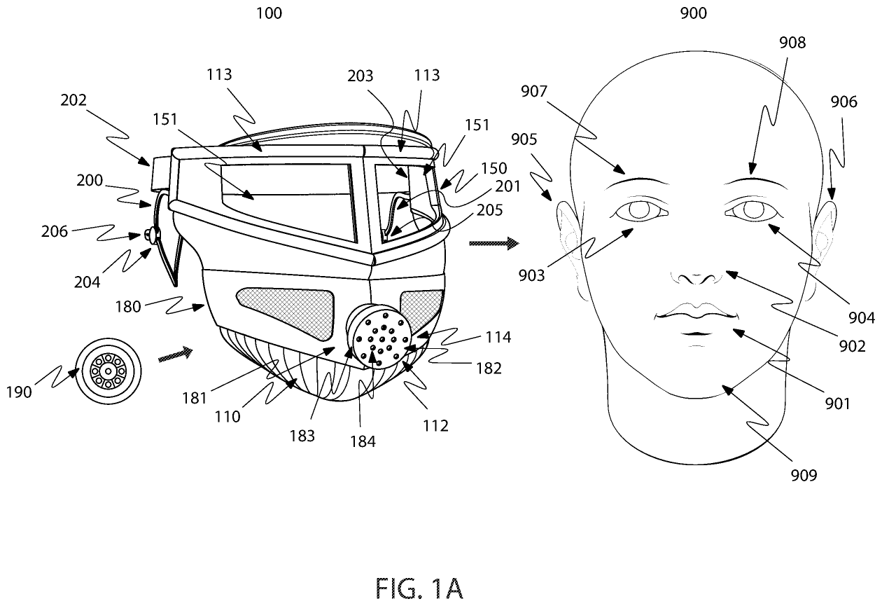

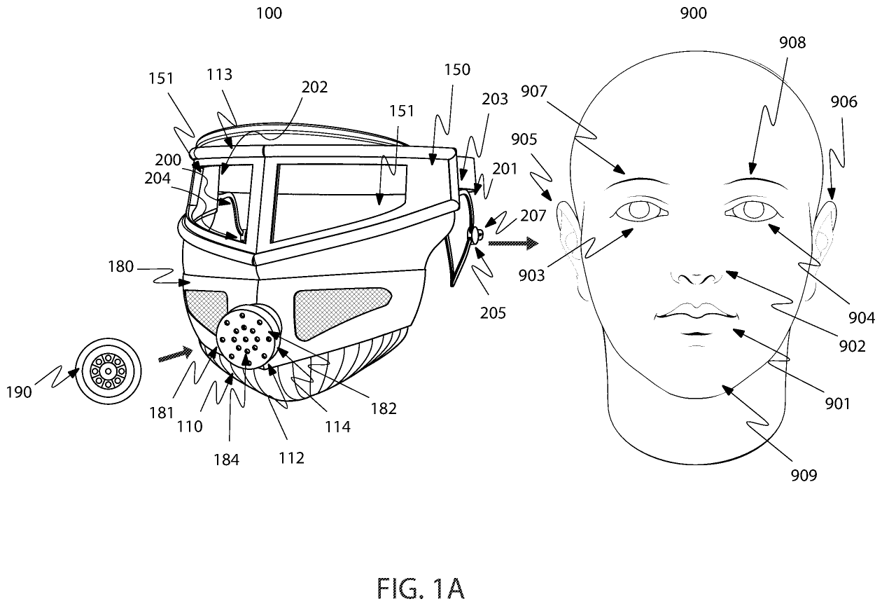

Referring to FIG. 1A and FIG. 1B, illustrated views of an exemplary full-faced shield 100 for protecting a person from microscopic virus and/or bacteria in the air is presented. The full-faced shield 100 is useful for providing an impervious protective layer for an entire face of a person. The full-faced shield 100 is useful for preventing droplets in the air from contacting eyes, nose and mouth area of the person. Furthermore, the full-faced shield 100 provides an enhanced level of protection compared to typical face masks.

A person 900 is presented such that the following detailed description can describe the full-faced shield in reference to the person 900. The person 900 has a mouth 901, a nose area 902, two (2) eyes 903, 904, two (2) ears 905, 906, two (2) eyebrows 907, 908 and a chin-line 909.

The full-faced shield 100 of FIG. 1A and FIG. 1B will be presented in a single entity although differences regarding one or the other will become obvious and discernable within this description.

The full-faced shield 100 is preferably made of a plastic material, however other materials are hereby contemplated, including, but not limited to, poly-vinyl chloride (PVC), high-density polyethylene (HDPE), low-density polyethylene (LDPE), etc. The full-faced shield 100 is preferably a clear color, however, other colors are hereby contemplated, including, but not limited to, opaque, blue, green, etc.

The full-faced shield 100 is preferably washable, however it is further contemplated that the full-faced shield 100 is non-washable. The full-faced shield 100 is preferably reusable, however it is further contemplated that the full-faced shield is disposable.

The full-faced mask 100 is preferably a width of the distance from a first of the ears 905 to a second of the ears 906, however it is further contemplated that other widths are further contemplated and within the scope of this application. The full-faced shield 100 preferably has a height from above the eyebrows 907, 908 to below the chin-line 909, however other heights are further contemplated and within the scope of this application.

The full-faced shield 100 has a shield 110, an eye protector 150 and a mouth and nose protector 180. The shield 100 has a filter apparatus 112. The filter apparatus 112 is configured to cover the mouth 901 and the nose area 902 of the person 900.

The shield 110 is preferably a single piece construction, however it is further contemplated that the shield 110 may be made in more than a single piece construction and coupled together to form the shield 110. The shield has two (2) first openings 113 and a second opening 114. The two (2) first openings 113 are configured to be at significantly near the eyes 903, 904 of the person 900 for sight. The second opening 114 is configured significantly near the mouth 901 and nose area 902 of the person 900 for breathing and talking purposes.

The eye protector 150 is coupled to the shield 110 significantly over the first openings 113. The eye protector 150 has a plurality of lenses 151, the lenses 151 of the eye protector 150 are significantly over the first openings 113 to protect the eyes 903, 904 and allow for vision.

The mouth and nose protector 180 is coupled to the shield 110 significantly over the second opening 114 to allow for protection of the mouth and nose from microscopic virus and bacterial particles. The mouth and nose protector 180 has a filter holder 181. The filter holder 181 is for holding a filter 190. The filter holder has a top 182, a body 183 and an interior 184. The top 182 of the filter holder 181 preferably is coupled to the body 183 by a coupling mechanism 185, shown in FIG. 1B. The coupling mechanism 185 is preferably a screw like coupling however other types of coupling mechanisms are hereby contemplated, including, but not limited to, hook and loop fasteners, such as Velcro®-like fasteners, compression coupling, etc.

The filter 190 is preferably disposable, however it is further contemplated that the filter 190 is reusable. FIG. 1B shows the filter 190 in the interior 185 of the filter holder 181 and further shows the coupling mechanism 185 of the filter holder 181.

The full-faced shield 100 has a plurality of straps 200, 201, 202, 203 the straps 200, 201, 202, 203 are configured to be coupled to the shield 110. Each of the straps 200, 201, 202, 203 are configured to be coupled to another of the straps 200, 201, 202, 203, The straps 200, 201, 202, 203 are for securing the full-faced shield 100 to the person 900. The straps 200, 201, 202, 203 may be coupled to another of the straps 200, 201, 202, 203 by a third connector 204. The third connector 204 is preferably a hook and loop fastener, such as a Velcro®-like fastener, however other types of connectors are hereby contemplated, including, but not limited to, snaps, clips, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A full-faced shield for protecting a person from microscopic virus and/or bacteria in the air, the full-faced shield comprising:
a shield, the shield comprising:
two (2) first openings, the first openings being configured to be substantially at a level of eyes of a person; and
a second opening, the second opening being substantially at the level of a mouth and a nose area of the person;
an eye protector, the eye protector having two lenses, wherein the eye protector being coupled to the shield, and wherein the two lenses being configured over the first openings of the eye protector, the lens of the eye protector being for allowing vision for the person;
a mouth and nose protector, the mouth and nose area protector having a second opening, wherein the mouth and nose protector being coupled to the shield, and wherein the second opening being configured to cover the second opening of the shield;
a plurality of straps, the straps being coupled to the shield, each of the straps being configured to be coupled to another of the straps by a third connector, wherein the straps for securing the full-faced shield to the person;
a filter holder, the filter holder having a top, a body and an interior, wherein the top being coupled to the body by a coupling; and
a filter, the filter being configured to be coupled to the interior of the filter holder.

2. The full-faced shield of claim 1, wherein the face shield having a width being from a first ear of a person to a second ear of the person.

3. The full-faced shield of claim 1, wherein the face shield having a height being from a forehead of a person to a chin-line of the person.

4. The full-faced shield of claim 1, wherein the third connector being a hook and loop fastener.

5. The full-faced shield of claim 1, wherein the full-faced shield being made of a plastic material.

6. The full-faced shield of claim 1, wherein the full-faced shield being clear in color.

7. The full-faced shield of claim 1, wherein the full-faced shield being reusable.

8. The full-faced shield of claim 1, wherein the full-faced shield being washable.

9. The full-faced shield of claim 1, wherein the filter being reusable.

10. The full-faced shield of claim 1, wherein the filter being disposable.

11. The full-faced shield of claim 1, wherein the full-faced shield being constructed of a single mold.
